(19) United States
(12) Patent Application Publication
(10) Pub. No.: US 2006/0007797 A1
(43) Pub. Date: Jan. 12, 2006

(54) Optical disk player

(75) Inventor: Satoshi Tsujimoto, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/171,538

(22) Filed: Jul. 1, 2005

(30) Foreign Application Priority Data
Jul. 9, 2004 (JP) 2004-203129

(51) Int. Cl. G11B 21/08; G11B 7/00

(52) U.S. Cl. 369/30.04; 369/53.21; 369/47.12

(57) ABSTRACT

If a media display key is depressed while the player stops the operation, playable media information is read from a flash ROM by a first media display processing unit and displayed on a display device. With the media display key being not depressed, if the optical disk is loaded, disk kind information is read out from the optical disk by a media determining unit. If it is determined by the media determining unit that the disk kind information read is not contained in the playable media information, the fact that the optical disk loaded is not playable is displayed on the display device by a playable/non-playable display processing unit. The playable media are displayed on the display device by a second display processing unit.

### BACKGROUND OF THE INVENTION

1. Field of the Invention

This invention relates to an optical disk player for reproducing information recorded on an optical disk, and more particularly to an optical disk player having a function capable of displaying playable media.

2. Description of the Related Art

In recent years, with diversification of large capacity media represented by an optical disk, a DVD (digital versatile disk)-VIDEO, a CD-DA (compact disk—digital audio), a Picture CD (picture compact disk), etc. have become widespread. An optical disk player having a function capable of playing these plural kinds of optical disks has also become widespread.

In using such an optical disk player, a user reads an instruction manual to confirm playable media. And if an optical disk to be played is contained in the playable media, he loads the optical disk in the optical disk player and plays the optical disk.

An optical disk player is also known in which with the contents of the instruction manual having been stored in the optical disk player itself, in using the optical disk player, the user reads out the contents of the instruction manual stored in the memory and displays them on a display device.

### SUMMARY OF THE INVENTION

However, where the user forgets the place where the instruction manual is kept or where he cannot see it because the other person keeps it, in the conventional optical disk player in which the user reads the instruction manual to confirm playable media, it is not possible to confirm what media are playable.

On the other hand, in the optical disk player which permits the contents of the instruction manual to be displayed, the capacity of the memory storing the contents of the instruction manual is increased, thus leading to an increase in the production cost.

Incidentally, JP-A-2002-334569 permits the kind of the disk loaded to be displayed, but does not display playable media (optical disks). JP-A-2003-173668 relates to a disk player in which a plurality of disks can be placed on a turn table, but belongs to a type different from the optical disk player according to this invention. JP-A-4-229479 permits the kind of the optical disk to be played to be displayed, but does not display playable media (optical disks). JP-A-5-128827 permits the kind of the disk to be confirmed in such a manner that the label face of a cartridge of a disk player can be seen through a window, but does not display playable media (optical disks). JP-A-2-101397 relates to a disk player for playing a plurality of disks with different diameters in which the light emitting color of a display segment is changed according to the kind of the disk, but does not display playable media (optical disks).

It is an object of the invention to provide an optical disk player capable of confirming instantaneously whether or not an optical disk to be loaded is playable by permitting playable media to be displayed.

According to one aspect of the invention, an optical disk player for reproducing information recorded on an optical disk, including: a system controller including:
a media display key operable to display playable media; a memory storing playable media information; a first media display processing unit reading out the playable media information from the memory when the media display key is depressed and displaying the playable media information; a media determining unit reading out disk kind information from the optical disk if the optical disk is loaded with the media display key being not depressed and determining whether or not the disk kind information thus read is contained in the playable media information stored in the memory; a playable/non-playable display processing unit displaying on the display device that the optical disk loaded is playable if it is determined that the disk kind information is contained in the playable media information, and the playable/non-playable display processing unit displaying on the display device that the optical disk loaded is not playable if it is determined that the disk kind information is not contained in the playable media information; and a second media display processing unit reading out the playable media information from the memory when the fact that the optical disk loaded is not playable is displayed on the display device by the playable/non-playable display processing unit, the second media display processing unit displaying playable media on the display device.

In this configuration, if a media display key is depressed while the player stops the operation, playable media information is read from the memory by the first media display processing unit and displayed on the display device. With the media display key being not depressed, if the optical disk is loaded, disk kind information is read out from the optical disk by the media determining unit. If it is determined by the media determining unit that the disk kind information read is contained in the playable media information, the fact that the optical disk loaded is playable is displayed on the display device by the playable/non-playable display processing unit.

On the other hand, if it is determined by the media determining unit that the disk kind information read is not contained in the playable media information, the fact that the optical disk loaded is not playable is displayed on the display device by the playable/non-playable display processing unit. Further, the playable media are also displayed on the display device by the second display processing unit.

In accordance with this configuration, when the media display key is depressed, the playable media can be displayed so that the user can know instantaneously whether or not the optical disk to be loaded is playable. In addition, if the optical disk loaded is not playable, the playable media are automatically displayed so that the user can confirm the playable media. Accordingly, the user who does not know what media can be played by the optical disk player used for playing, without reading an instruction manual, can confirm instantaneously the playable media, and enjoy many played media belonging to the playable media.

According to another aspect of the invention, an optical disk player for reproducing information recorded on an optical disk, including: a system controller including; a media display key operable to display playable media; a memory storing playable media information; a first media display processing unit reading out the playable media information from the memory when the media display key is depressed and displaying the playable media information thus read on a display device.

In this configuration, if a media display key is depressed while the player stops the operation, playable media information is read from the memory by the first media display processing unit and displayed on the display device.

In accordance with this configuration, when the media display key is depressed, the playable media can be displayed so that the user can know instantaneously whether or not the optical disk to be loaded is playable. Accordingly, the user who does not know what media can be played by the optical disk player used for playing, without reading an instruction manual, can confirm instantaneously the playable media, and enjoy many played media belonging to the playable media.

According to another aspect of the invention, the system controller further includes: a media determining unit reading out disk kind information from the optical disk if the optical disk is loaded with the media display key being not depressed and determining whether or not the disk kind information thus read is contained in the playable media information stored in the memory; a playable/non-playable display processing unit displaying on the display device that the optical disk loaded is playable if it is determined that the disk kind information is contained in the playable media information and displaying on the display device that the optical disk loaded is not playable if it is determined that the disk kind information is not contained in the playable media information; and a second media display processing unit reading out the playable media information from the memory when the fact that the optical disk 1 loaded is not playable is displayed on the display device by the playable/non-playable display processing unit, thereby displaying playable media on the display device.

According to the above-aspects of the invention, with a media display key operated to display playable media being provided and playable media information being previously stored in a memory, a system controller is configured to include: a first media display processing unit for reading out the playable media information from the memory when the media display key is depressed and displaying the playable media information thus read on a display device; a media determining unit for reading out disk kind information from the optical disk if the optical disk is loaded with the media display key being not depressed and determining whether or not the disk kind information thus read is contained in the playable media information stored in the memory; a playable/non-playable display processing unit for displaying on the display device that the optical disk loaded is playable if it is determined that the disk kind information is contained in the playable media information and for displaying on the display device that the optical disk loaded is not playable if it is determined that the disk kind information is not contained in the playable media information; and a second media display processing unit for reading out the playable media information from the memory when the fact that the optical disk loaded is not playable is displayed on the display device by the playable/non-playable display processing unit, thereby also displaying playable media on the display device. For this reason, when the media display key is depressed, the playable media can be displayed so that the user can know instantaneously whether or not the optical disk to be loaded is playable. In addition, if the optical disk loaded is not playable, the playable media are automatically displayed so that the user can confirm the playable media. Accordingly, the user who does not know what media can be played by the optical disk player used for playing, without reading an instruction manual, can confirm instantaneously the playable media, and enjoy many played media belonging to the playable media.

According to the above-aspects of the invention, with a media display key operated to display playable media being provided and playable media information being previously stored in a memory, a system controller is configured to comprise a first media display processing unit for reading out the playable media information from the memory when the media display key is depressed and displaying the playable media information thus read on a display device. For this reason, when the media display key is depressed, the playable media can be displayed so that the user can know instantaneously whether or not the optical disk to be loaded is playable. Accordingly, the user who does not know what media can be played by the optical disk player used for playing, without reading an instruction manual, can confirm instantaneously the playable media, and enjoy many played media belonging to the playable media.

### BRIEF DESCRIPTION OF THE DRAWINGS

FIG. 1 is a block diagram showing the configuration of an optical disk player according to an embodiment of this invention.

FIG. 2 is a flowchart for explaining the processing in displaying media in the embodiment.

FIG. 3 is a view showing an example displayed on the display device indicating what media are playable in the embodiment.

FIG. 4 is a view showing an example displayed on the display device indicating that the optical disk loaded is playable in the embodiment.

FIG. 5 is a view showing an example displayed on the display device indicating that the optical disk loaded is not playable and what media are playable according to the embodiment.

### DESCRIPTION OF THE PREFERRED EMBODIMENTS

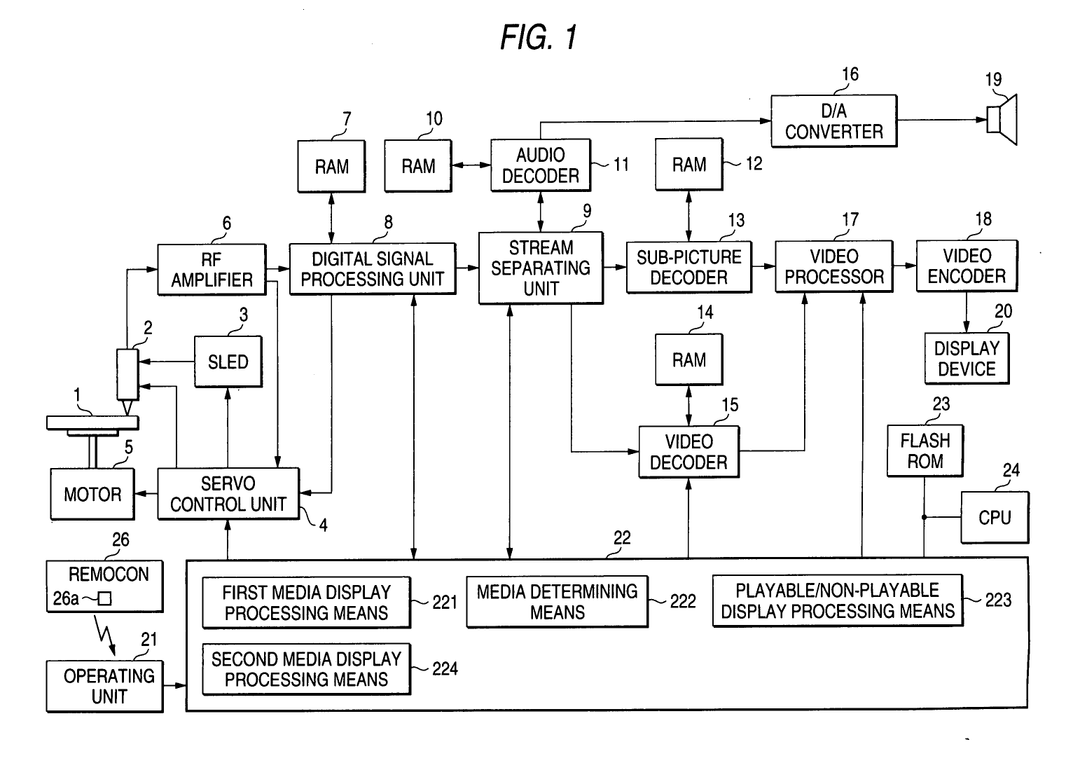

Now referring to the attached drawings, an explanation will be given of an embodiment of this invention. FIG. 1 is a block diagram showing the configuration of the optical disk player according to an embodiment of this invention.

The optical disk player includes a spindle motor 5 for rotating an optical disk 1; an optical pickup 2 for emitting a laser beam for reproducing information recorded on the optical disk 1 and receiving the beam reflected from the optical disk 1; a sled 3 for moving the optical disk 2 in a radial direction of the optical disk 1; and a servo control unit 4 of making control of moving the focal point of the laser beam vertically and horizontally for a recording face of the optical disk 1 by driving the spindle motor 5 and sled 3 and moving an objective lens (not shown) incorporated in the optical pickup 2 according to an instruction by a system controller 22.

The optical disk player further includes an RF amplifier 6 for amplifying an RF signal which is a signal read from the optical pickup during playing of the optical disk 1; a digital signal processing unit 8 for converting the RF signal outputted from the RF amplifier 6 into digital data, thereafter subjecting the digital data to signal decoding processing and error correction processing corresponding to the data format of the optical disk 1 and storing the data thus created in a RAM 7; and a stream separating unit 9 for separating audio data, sub-picture data and video data from one another from among the data stream outputted from the digital signal processing unit 8 according to an instruction by the system controller 22.

The optical disk player further includes an audio decoder 11 for executing predetermined decoding processing for the audio data outputted from the stream separating unit 9; a RAM 10 for temporarily storing the data to be subjected to the decoding processing by the audio decoder 11; a sub-picture decoder 13 for executing predetermined decoding processing for the sub-picture data outputted from the stream separating unit 9; a RAM 12 for temporarily storing the data to be subjected to the decoding processing by the sub-picture decoder 13; a video decoder 15 for executing predetermined decoding for the video data outputted from the stream separating unit 9; and a RAM 14 for temporarily storing the data to be subjected to the decoding processing by the video decoder 15.

The optical disk player further includes a video processor 17 for synthesizing data outputted from the video decoder 15 and data outputted from the sub-picture decoder 13 according to an instruction by the system controller 22; a video encoder 18 for converting the synthesized data outputted from the video processor 17 into a video signal for display and displaying the resultant image on a display device 20; and a D/A converter 16 for converting the data outputted from the audio decoder 11 into an analog audio signal to be supplied to e.g. a speaker 19.

The optical disk player further includes an operating unit 21 having a play key (not shown) for giving an instruction of play, a stop key for giving an instruction of play stopping and other various operation keys (not shown); and the above system controller 22 for controlling the entire player. The operating unit 21 is provided with a light-receiving unit (not shown) for receiving an optical signal indicative of an operation command from a remocon (remote controller) 26. The light-receiving unit converts the optical signal received into an electric signal which is supplied to the system controller 22 as a command signal. The remocon 26 includes, in addition to various operation keys which are identical to those of the operating unit 21, a media display key 26a which is operated in order to display playable media. Incidentally, the media display key 26a may be provided on the operating unit 21.

The optical disk player further includes a flash ROM 23 for storing a program and data used for controlling the respective components of the player and the entire player, and a CPU 24 for executing the operation processing according to the program and data stored in the flash ROM 23 to control the system controller 22. The flash ROM stores playable media information which represents the media which can be played by the optical disk player according to this embodiment.

The system controller 22 includes constituent components which characterizes this embodiment, i.e. a first media display processing unit 221 for reading out the playable media information from the flash ROM 23 when the media display key 26a is depressed and displaying the playable media information on a display device 20; a media determining unit 222 for reading out disk kind information from the optical disk 1 if the optical disk 1 is loaded with the media display key 26 being not depressed and determining whether or not the disk kind information thus read is contained in the playable media information stored in the flash ROM 23; a playable/non-playable display processing unit 223 for displaying on the display device 20 that the optical disk loaded is playable if it is determined that the disk kind information is contained in the playable media information and for displaying on the display device 20 that the optical disk loaded is not playable if it is determined that the disk kind information is not contained in the playable media information; and a second media display processing unit 224 for reading out the playable media information from the flash ROM 23 when the fact that the optical disk 1 loaded is not playable is displayed on the display device 20 by the playable/non-playable display processing unit 223, thereby also displaying playable media on the display device 20.

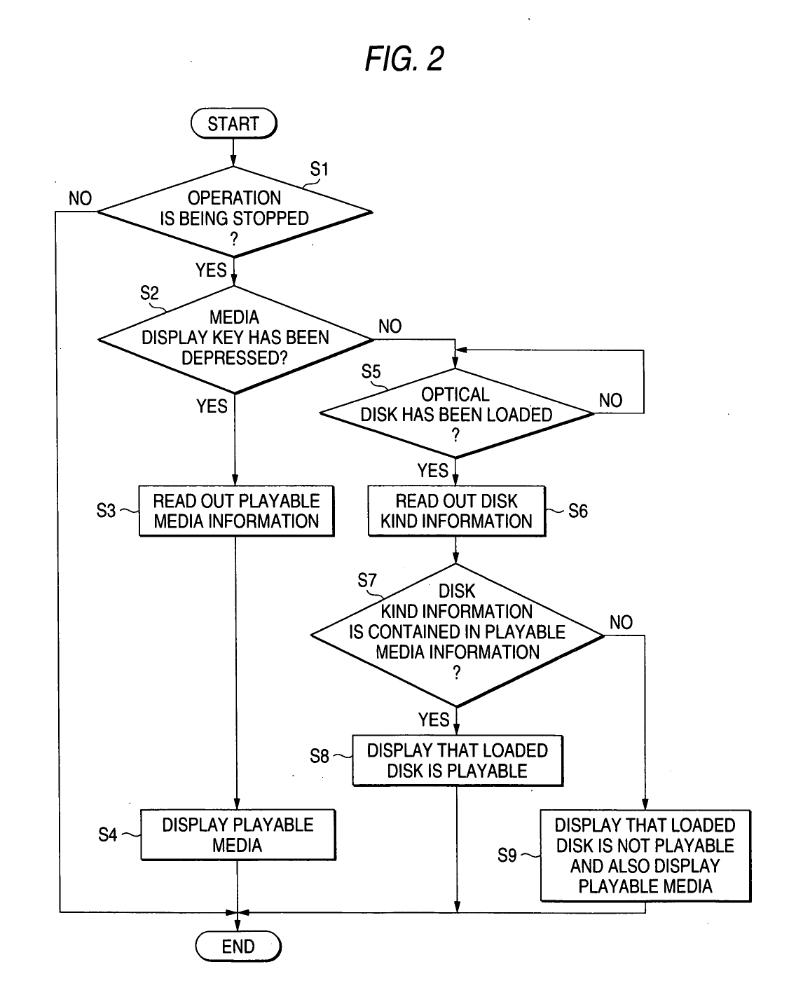

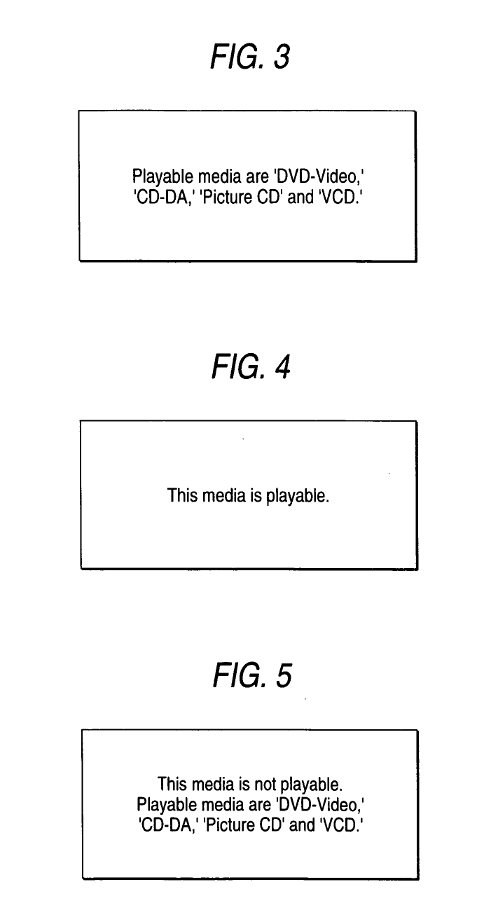

FIG. 2 is a flowchart for explaining the processing in displaying the media according to this embodiment. FIG. 3 is a view showing an example displayed on the display device indicating what media are playable in this embodiment. FIG. 4 is a view showing an example displayed on the display device indicating that the optical disk loaded is playable in this embodiment. FIG. 5 is a view showing an example displayed on the display device indicating that the optical disk loaded is not playable and what media are playable according to this embodiment.

Now referring to FIGS. 1 to 5, an explanation will be given of the processing of displaying playable media according to this embodiment. While the apparatus (player) stops processing (stops playing processing or stops seek processing) (step S1), if the media display key 26a on the remocon is depressed (step S2), an infrared ray media displaying command signal is transmitted from the remocon 26. The signal transmitted is converted into an electric signal by the operating unit 21 and the electric signal is supplied to the system controller 22.

In the system controller 22, playable media information is read out from the flash ROM 23 by the first media display processing unit 221 (step S3). The playable media information read is decoded by the video decoder 15. Further, the playable media information decoded is supplied to the video encoder 18 through the video processor 17 so that it is converted into the video signal for display. When the video signal is supplied to the display device 20, for example as shown in FIG. 3, displayed on the display device 20 is a message that “playable media are ‘DVD-VIDEO’, ‘CD-DA’, ‘Picture CD’ and ‘VCD’. In short, the first media display processing unit 221 displays the playable media on the display device 20 (step S4).

On the other hand, with the media display key 26a of the remocon 26 being not depressed (step S2), if the optical disk 1 is loaded, the system controller 22 controls the servo control unit 4 to rotate the spindle motor 5, thereby rotating the optical disk 1. Further, the system controller 22 controls the optical pickup 2 to access a TOC (Table of Contents) region of the optical disk 1. The media determining unit 222 reads out the TOC information from the TOC region and disk kind information contained in the TOC information (step S6) and determines whether or not the disk kind information read is contained in the playable media information stored in the flash ROM 23 (step S7).

For example, if the optical disk 1 loaded is a VCD, since the VCD is contained in the playable media as shown in FIG. 3, the media determining unit 222 determines that the disk kind information is contained in the playable media information stored in the flash ROM 23. Then, the playable/non-playable display processing unit 223 displays on the display device 20 the message indicating that the optical disk 1 loaded is playable, for example “this media is playable” as shown in FIG. 4. In short, the playable/non-playable display processing unit 223 of the system controller 22 displays on the display device 20 the fact that the optical disk loaded is playable (step S8).

On the other hand, if it is determined that the disk kind information is not contained in the playable media information stored in the flash ROM 23 (step S7), the playable/non-playable display processing unit 223 displays the fact that the loaded disk is not playable and the second media display processing unit 224 displays playable media (step S9). For example, as shown in FIG. 5, displayed on the display device 20 is the message that “this media is not playable. The playable media are ‘DVD-VIDEO’, ‘CD-DA’, ‘Picture CD’ and ‘VCD’”. The display device 20 may display a kind of the playable media. Herein, the playable media may further include DVD-VR, DVD-AUDIO, MP3, WMA (Windows Media Audio), SACD, DIVX.

As understood from the description hitherto made, in accordance with this embodiment, when the media display key 26a of the remocon 26 is depressed, the playable media can be displayed on the display device 20 so that the user can know instantaneously whether or not the optical disk 1 to be loaded is playable. In addition, if the optical disk 1 loaded is not playable, the playable media are automatically displayed on the display device 20 so that the user can confirm the playable media. Accordingly, the user who does not know what media can be played by the optical disk player used for playing, without reading an instruction manual, can confirm instantaneously the playable media, and enjoy many played media belonging to the playable media.

What is claimed is:

1. An optical disk player for reproducing information recorded on an optical disk, comprising:
a system controller including:
a media display key operable to display playable media;
a memory storing playable media information;
a first media display processing unit reading out the playable media information from the memory when the media display key is depressed and displaying the playable media information;
a media determining unit reading out disk kind information from the optical disk if the optical disk is loaded with the media display key being not depressed and determining whether or not the disk kind information thus read is contained in the playable media information stored in the memory;
a playable/non-playable display processing unit displaying on the display device that the optical disk loaded is playable if it is determined that the disk kind information is contained in the playable media information, and the playable/non-playable display processing unit displaying on the display device that the optical disk loaded is not playable if it is determined that the disk kind information is not contained in the playable media information; and
a second media display processing unit reading out the playable media information from the memory when the fact that the optical disk loaded is not playable is displayed on the display device by the playable/non-playable display processing unit, the second media display processing unit displaying playable media on the display device.

2. An optical disk player for reproducing information recorded on an optical disk, comprising:
a system controller including;
a media display key operable to display playable media;
a memory storing playable media information;
a first media display processing unit reading out the playable media information from the memory when the media display key is depressed and displaying the playable media information thus read on a display device.

3. An optical disk player according to claim 2, wherein the system controller further includes:
a media determining unit reading out disk kind information from the optical disk if the optical disk is loaded with the media display key being not depressed and determining whether or not the disk kind information thus read is contained in the playable media information stored in the memory;
a playable/non-playable display processing unit displaying on the display device that the optical disk loaded is playable if it is determined that the disk kind information is contained in the playable media information and displaying on the display device that the optical disk loaded is not playable if it is determined that the disk kind information is not contained in the playable media information; and
a second media display processing unit reading out the playable media information from the memory when the fact that the optical disk 1 loaded is not playable is displayed on the display device by the playable/non-playable display processing unit, thereby displaying playable media on the display device.
